(19) United States
(12) Patent Application Publication
(10) Pub. No.: US 2017/0130865 A1
(43) Pub. Date: May 11, 2017

(54) Valve Security Device

(71) Applicant: Alliance for Sustainable Energy, LLC, Golden, CO (US)

(72) Inventors: Guido Bender, Arvada, CO (US); Phillip Clark, Lakewood, CO (US)

(21) Appl. No.: 15/344,103

(22) Filed: Nov. 4, 2016

Related U.S. Application Data
(60) Provisional application No. 62/252,244, filed on Nov. 6, 2015.

(51) Int. Cl. F16K 35/10; E05B 67/38; F16K 35/06

(52) U.S. Cl. CPC F16K 35/10; F16K 35/06; E05B 67/383; F16K 31/60

(57) ABSTRACT

A device includes a control cover having a body portion with a first surface. The control cover also has at least one cavity in the first surface. The control cover may include a plurality of prongs, each of which extends, from the first surface, along a respective axis that intersects the first surface. At least one prong of the plurality of prongs includes a respective aperture configured to receive a locking mechanism. The control cover may include a compressible material disposed within the cavity that fills at least a portion of the cavity. The control cover may include at least one aperture configured to receive at least one locking mechanism.

### CROSS-REFERENCE TO RELATED APPLICATIONS

This application claims the benefit of U.S. Provisional Patent Application No. 62/252,244, filed Nov. 11, 2015, the entire content of which is incorporated herein by reference.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

Pipes and other conduits are ubiquitous in today's society. Pipes may transport water, steam, sewage, chemicals, gases, oil, plumbers, or other matter from one point to another. Similarly, other conduits may provide for the transportation of electricity or other resources. Such flows can be modified, limited, or even cut off by the use of valves. In some situations, it can be useful to secure the controls of such valves to avoid incorrect or unauthorized use, including on a temporary basis. As one example, safety laws may require securely locking out valve controls to prevent changes during use, maintenance, repair, etc.

### SUMMARY

In one example, a device includes a control cover that includes: a body portion having a first surface, at least one cavity in the first surface, and a plurality of prongs, each of which extends, from the first surface, along a respective axis that intersects the first surface. At least one prong of the plurality of prongs includes a respective aperture configured to receive a locking mechanism.

In another example, a device includes a control cover that includes: a body portion having a first surface, at least one cavity in the first surface, a compressible material disposed within the cavity that fills at least a portion of the cavity, and at least one aperture configured to receive at least one locking mechanism.

In another example, a device includes a control cover that includes: a body portion having a first surface, at least one cavity in the first surface, at least one removable insert that, when inserted into the cavity, modifies a shape of the cavity, and at least one aperture configured to receive at least one locking mechanism.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a perspective diagram illustrating one example of a security device, in accordance with one or more aspects of the present disclosure.

FIG. 2 is a perspective diagram illustrating another example of a security device, in accordance with one or more aspects of the present disclosure.

FIG. 3 is a perspective diagram illustrating another example of a security device, in accordance with one or more aspects of the present disclosure.

FIGS. 4A-4C are diagrams illustrating additional views of the control cover shown in FIGS. 1-3.

FIGS. 5A-5C are diagrams illustrating another example of a control cover of a security device, in accordance with one or more aspects of the present disclosure.

FIGS. 6A and 6B are diagrams illustrating an example of a control cover of a security device and a corresponding valve, in accordance with one or more aspects of the present disclosure.

FIGS. 7A and 7B are diagrams illustrating an example of a control cover of a security device and a corresponding valve, in accordance with one or more aspects of the present disclosure.

FIGS. 8A and 8B are diagrams illustrating an example of a control cover of a security device and an associated insert, in accordance with one or more aspects of the present disclosure.

FIG. 9 is a diagram illustrating an example of a control cover of a security device, in accordance with one or more aspects of the present disclosure.

FIG. 10 is a diagram illustrating an example of a control cover of a security device, in accordance with one or more aspects of the present disclosure.

FIG. 11 is a diagram illustrating an example of a control cover of a security device, in accordance with one or more aspects of the present disclosure.

### DETAILED DESCRIPTION

The present disclosure may provide slim, customizable security devices for restricting access to valve controls. For instance, the devices described herein may be used as “lockout” devices to ensure that the flow of potentially hazardous materials remains isolated during maintenance by preventing valves that control such flow from being adjusted. The term “valve”, as used herein, may refer to any device used for halting or controlling the flow of a liquid, gas, or other material or intangible substance (e.g., electricity, information, etc.) through a passage, a pipe, an inlet, an outlet, or another conduit.

The devices described herein may provide a more versatile safety solution than related art devices. For instance, in some examples, devices of the present disclosure need not be permanently or semi-permanently attached to a valve or conduit in order to be used. Instead, the devices can be both applied to and removed from the valve with little effort and without modification of the valve and/or the conduit. Additionally, in some examples, the slim nature of the devices described herein may allow use in cramped quarters, where limited space is available around a target valve. Furthermore, in some examples, the simple structure of the described devices may allow for more cost-effective construction, such as via 3D printing, injection molding, die casting, or any other suitable method. Additionally, the devices described herein may, in some examples, allow an operator to verify the valve control position while the device is engaged, which may be useful prior to and/or while engaging in maintenance activities.

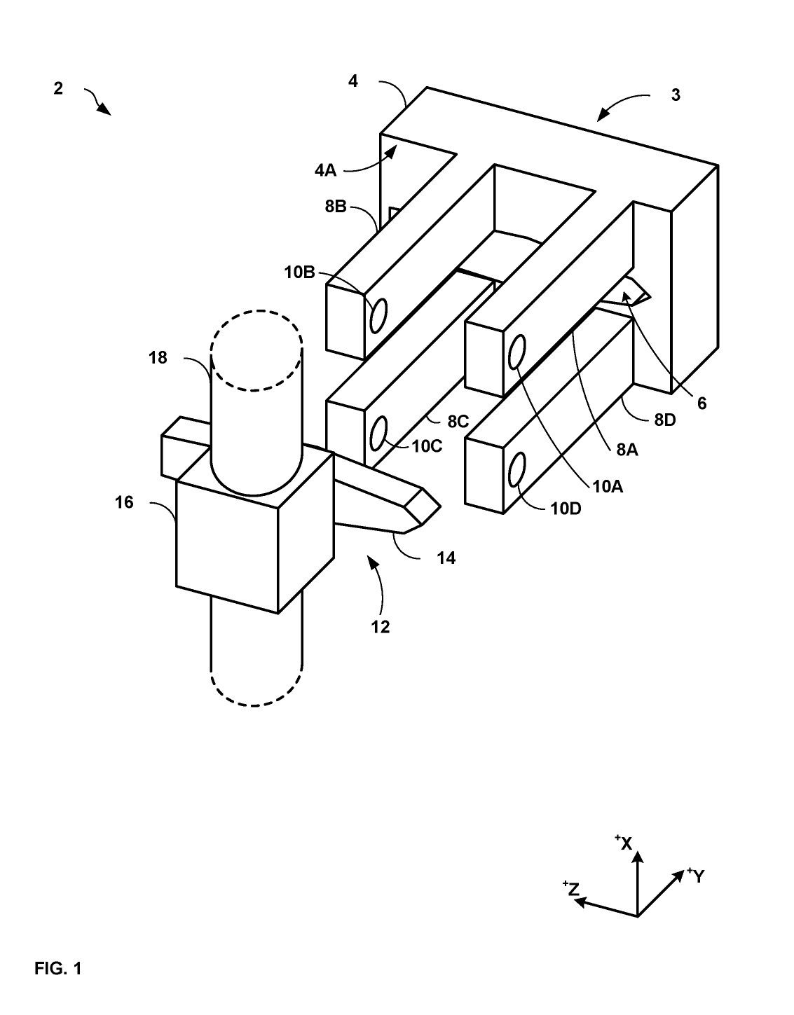

FIG. 1 is a perspective diagram illustrating an example security device 2, in accordance with one or more aspects of the present disclosure. FIG. 1 illustrates only one example configuration of security device 2, and other configurations may be used in various examples. FIG. 1 is for illustration purposes only and is not to scale.

In the example of FIG. 1, security device 2 includes control cover 3. Control cover 3 may be configured to secure valve controls. Control cover 3, as shown in the example of FIG. 1, includes body portion 4. Body portion 4 may have one or more surfaces, such as surface 4A. In some examples, surface 4A may be oriented substantially parallel to a plane. In the example of FIG. 1, for instance, surface 4A is oriented substantially parallel to the X-Z plane. In other examples, surface 4A may be curved or be otherwise non-planar.

Body portion 4 may include at least one cavity 6 in surface 4A. Cavity 6 may have depth in the positive Y direction. In various examples, cavity 6 may have any number of different shapes and/or sizes. In some examples, body portion 4 may include multiple cavities. That is, while body portion 4 is shown in the example of FIG. 1 as having a single cavity, in other examples body portion 4 may include multiple cavities. Cavity 6 in surface 4A may be configured such that cavity 6 may receive at least a portion of a valve control. In other words, cavity 6 may function as a socket into which the control of a valve may be at least partially inserted.

In the example of FIG. 1, control cover 3 includes a plurality of prongs 8A-8D (collectively “prongs 8”). Each of prongs 8 may extend, from surface 4A, along a respective axis that intersects surface 4A. For instance, in the example of FIG. 1, each of prongs 8 may extend along a respective axis that intersects the X-Z plane. Thus, in the example of FIG. 1, the respective axes are the same. That is, each of prongs 8 extends substantially perpendicular to the X-Z plane. In some examples, however, one or more of prongs 8 may extend in different directions. For example, prongs 8 may each extend in various directions in order to accommodate valves of different sizes and/or shapes.

Prongs 8, as shown in the example of FIG. 1, include respective apertures 10A-10D (collectively “apertures 10”). One or more of apertures 10 may be configured to receive a locking mechanism (not shown). For instance, one or more of apertures 10 may be configured to receive a shank of a padlock or another suitable locking mechanism. In some examples, all of apertures 10 may be configured and oriented such that a single locking mechanism may fit through all of apertures 10 at the same time. For example, a removable, U-shaped shank of a padlock may be fitted through all four of apertures 10. In some examples, one or more of apertures 10 may be configured and oriented such that a single locking mechanism may fit through a subset of apertures 10 and sufficiently secure control cover 3. In some examples, one or more of apertures 10 may be configured and oriented such that two or more locking mechanisms may each be fitted through a respective subset of apertures 10. While shown in the example of FIG. 1 as each having a respective aperture, prongs 8 may not, in some examples, each include a respective aperture. That is, in some examples, one or more of prongs 8 may not include an aperture. Additionally, in some examples, one or more of prongs 8 may include multiple apertures or a single, semi-divided aperture. Multiple apertures or semi-divided apertures may enable prongs 8 to receive a locking mechanism at various locations along prongs 8.

In the example of FIG. 1, security device 2 may be used to restrict movement of a valve control, thereby prohibiting any change in flow controlled by the valve. For instance, security device 2 may be used to restrict valve control 14 of valve 12. As shown in the example of FIG. 1, valve 12 includes valve control 14 and valve housing 16. Valve 12 may control the flow of a material (e.g., a liquid, a gas, etc.) through pipe 18. For instance, valve 12 may be a ball valve that uses a hollow, perforated, pivoting ball to control flow through pipe 18. As such, flow may be allowed or prevented by rotation of valve control 14. In one example, when valve control 14 is substantially parallel to pipe 18, valve 12 may be open, allowing for maximum flow through pipe 18. When valve control 14 is substantially perpendicular to pipe 18, as illustrated in the example of FIG. 1, valve 12 may be closed, restricting any flow through pipe 18.

In one example, security device 2 may be used by moving control cover 3 in the negative Y direction such that prongs 8A and 8D pass on one side of valve housing 16 and prongs 8B and 8C pass on the opposite side of valve housing 16. As control cover 3 is moved further in the negative Y direction, valve control 14 may at least partially enter cavity 6 of body portion 4. Once apertures 10 of prongs 8 are past valve housing 16 and/or pipe 18, a locking mechanism (not shown) may be placed through at least one of apertures 10 and subsequently locked. Thereafter, control cover 3 cannot be substantially moved in the positive Y direction until the locking mechanism is unlocked, and removed from apertures 10. Furthermore, with valve control 14 at least partially within cavity 6, body portion 4 of control cover 3 may restrict any substantial movement of valve control 14, thereby ensuring that the flow through pipe 18 remains off until the locking mechanism is unlocked and removed from apertures 10, and control cover 3 is subsequently removed from valve 12.

In this way, security device 2 may provide an easy, detachable solution for locking a valve in a current position. The devices described herein may be configured to fit almost any size and/or type of valve. Additionally, because the devices described herein are detachable, valves do not need any extra components or mechanisms cluttering up the area during regular use. Furthermore, the devices described herein may be backwards compatible with currently existing valves, so no system changes need be made to take advantage of the devices described herein. Restricting access to valve controls may allow utility workers or others to implement system maintenance without endangering worker safety. That is, the security devices described herein may be used by utility workers to lock out others' access while the utility worker performs any needed maintenance or modifications on downstream systems.

FIG. 2 is a perspective diagram illustrating an example security device 32, in accordance with one or more aspects of the present disclosure. In the example of FIG. 2, security device 32 includes control cover 3. Control cover 3 may be substantially the same as described with respect to FIG. 1. Additionally, pipe 18, valve 12, valve control 14, and valve housing 16, as shown in the example of FIG. 2, may be substantially as described with respect to FIG. 1. FIG. 2 is for illustration purposes only and is not to scale.

In the example of FIG. 2, security device 32 further includes backplate 50. Backplate 50 may be made of metal, plastic, or any other suitable material. In some examples, backplate 50 may have a substantially thin, planar shape. For instance, backplate 50 may have a thickness of approximately 1-5 millimeters. Backplate 50 may be configured to interface with control cover 3 and thereby assist in securing valve control 14 of valve 12.

In the example of FIG. 2, backplate 50 includes apertures 52A-52D (collectively “apertures 52”). Apertures 52 may be configured to allow prongs 8 to pass through backplate 50. While shown in the example of FIG. 2 as including four apertures, backplate 50 may, in other examples, include any number of apertures. For instance, in some examples, backplate 50 may include only a single aperture configured to receive one or all prongs of a control cover.

Prongs 8, in the example of FIG. 2, may be of a length sufficient to allow access to apertures 10 after prongs 8 pass through apertures 52 of backplate 50. In this way, one or more of apertures 10 may be configured to receive one or more locking mechanisms (not shown) after prongs 8 are fitted through apertures 52 of backplate 50. By inserting the locking mechanism(s) into one or more of apertures 10 after prongs 8 have been inserted through apertures 52, the locking mechanism may restrict prongs 8 from being removed from apertures 52 of backplate 50.

Backplate 50 may provide additional security in various examples, such as when relatively smaller locking mechanism(s) are used. For instance, a small padlock placed through one of apertures 10 may not sufficiently secure control cover 3 to valve 12, as the padlock may, in some examples, be slid past valve housing 16. In contrast, the small padlock may be unable to fit through apertures 52 of backplate 50, and thus security device 32 will remain secure even with small locking mechanisms. Furthermore, backplate 50 may help to prevent tampering with security device 32. For instance, backplate 50 may add an additional support point for prongs 8, such that it would be more difficult for someone to pry one or more of prongs 8 in unintended directions. Thus, the addition of backplate 50, in some examples, may improve the likelihood that security device 32 remains secure.

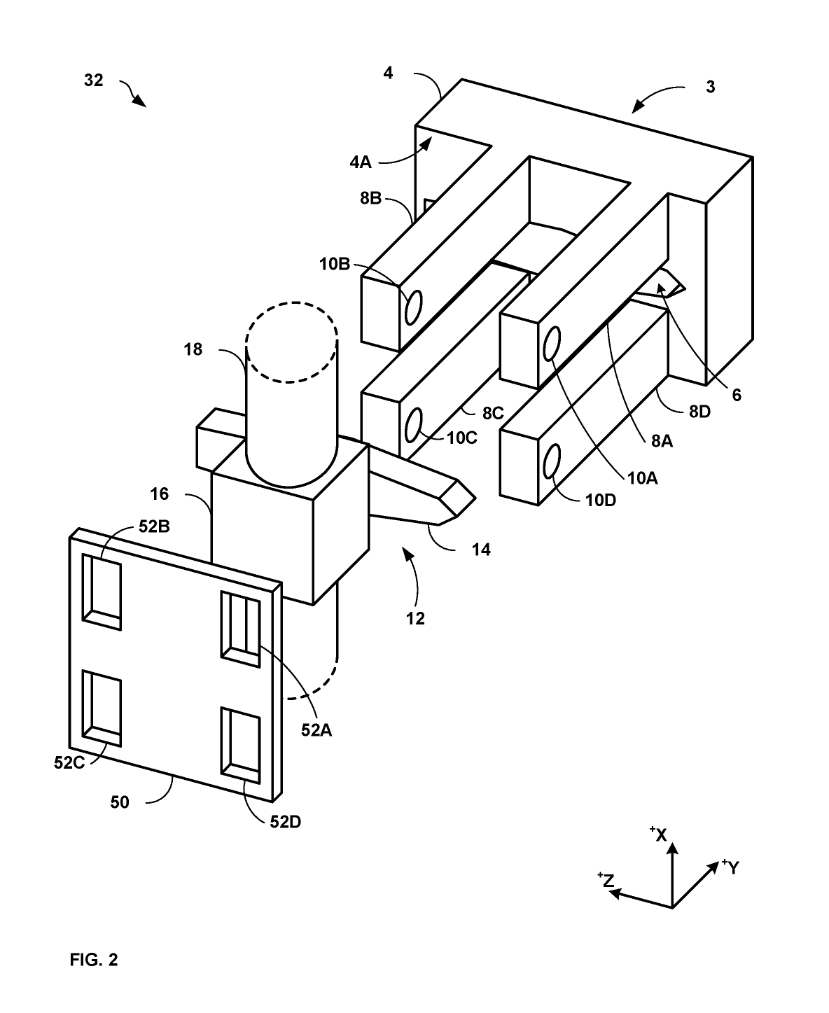

FIG. 3 is a perspective diagram illustrating an example security device 62, in accordance with one or more aspects of the present disclosure. In the example of FIG. 3, security device 62 includes control cover 3 and backplate 50. Control cover 3 may be substantially the same as described with respect to FIGS. 1 and 2 and backplate 50 may be substantially the same as described with respect to FIG. 2. Valve 12, as shown in the example of FIG. 3, may be substantially as described with respect to FIGS. 1 and 2. FIG. 3 is for illustration purposes only and is not to scale.

As shown in the example of FIG. 3, control cover 3 has been fitted over valve 12. Valve control 14 of valve 12 now resides within cavity 6. Consequently, valve control 14 is restricted by body portion 4 of control cover 3. Furthermore, prongs 8 of control cover 3 have been fitted through apertures 52 of backplate 50. In other words, valve 12 has been sandwiched between control cover 3 and backplate 50.

In some examples, some or all of control cover 3 (e.g., at least a portion of body portion 4) may be made of a transparent or semi-transparent material. At least partial transparency may allow a user of security device 62 to easily learn the status of valve control 14 while security device 62 is engaged. For instance, transparency may allow a user to see inside cavity 6 through a surface of body portion 4, such as the surface opposite surface 4A. Consequently, when security device 62 is engaged, as shown in the example of FIG. 3, the user can still see the position of valve control 14 and validate that it is safe to perform work that requires valve control 14 to be in that position.

In the example of FIG. 3, security device 62 includes locking mechanism 64. Locking mechanism 64 represents only one example of a locking mechanism, and various other locking mechanisms may be used in other examples. In some examples, security device 62 may not include any locking mechanism. Locking mechanism 64, in the example of FIG. 3, includes shank 65. Shank 65 has been fitted through each of apertures 10, thereby ensuring that prongs 8 may not be removed from apertures 52 of backplate 50. Consequently, control cover 3 may not be removed from valve 12.

While locking mechanism 64 shown in the example of FIG. 3 may, in some examples, be sufficient on its own to ensure control cover 3 remains in place, backplate 50 may serve as an additional support point for prongs 8. Furthermore, in examples using a different locking mechanism (e.g., a small padlock having a shank that can fit through only a single one of apertures 10 at a time), backplate 50 may ensure that the locking mechanism (and thus any of prongs 8 to which the locking mechanism is attached) is prohibited from sliding past valve 12.

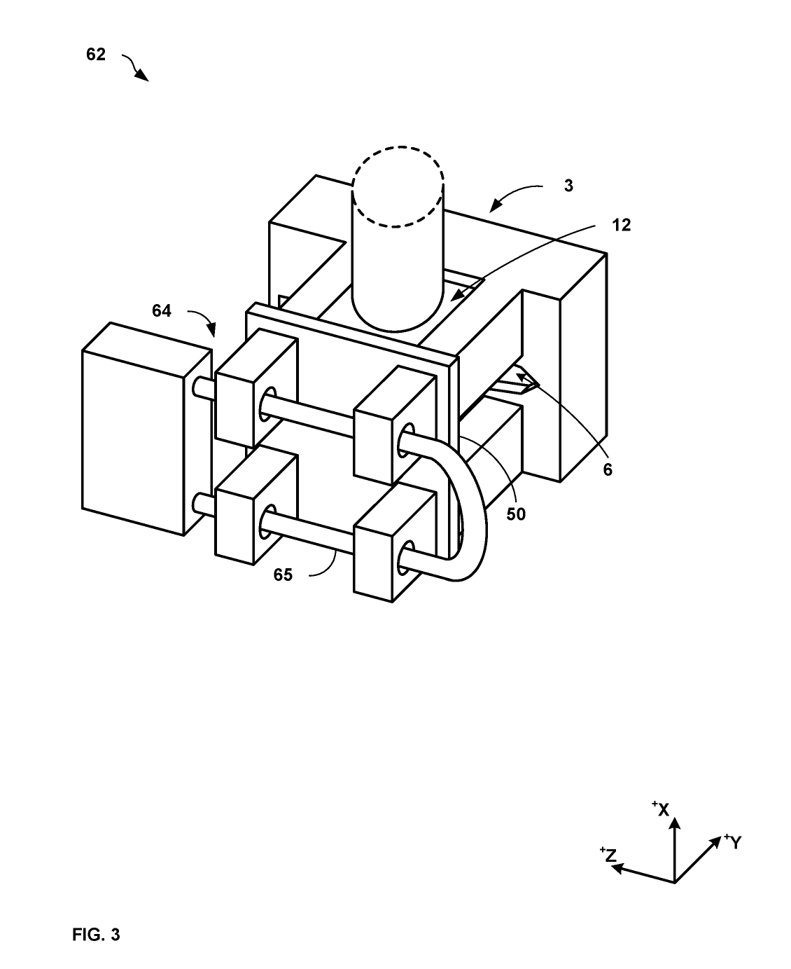

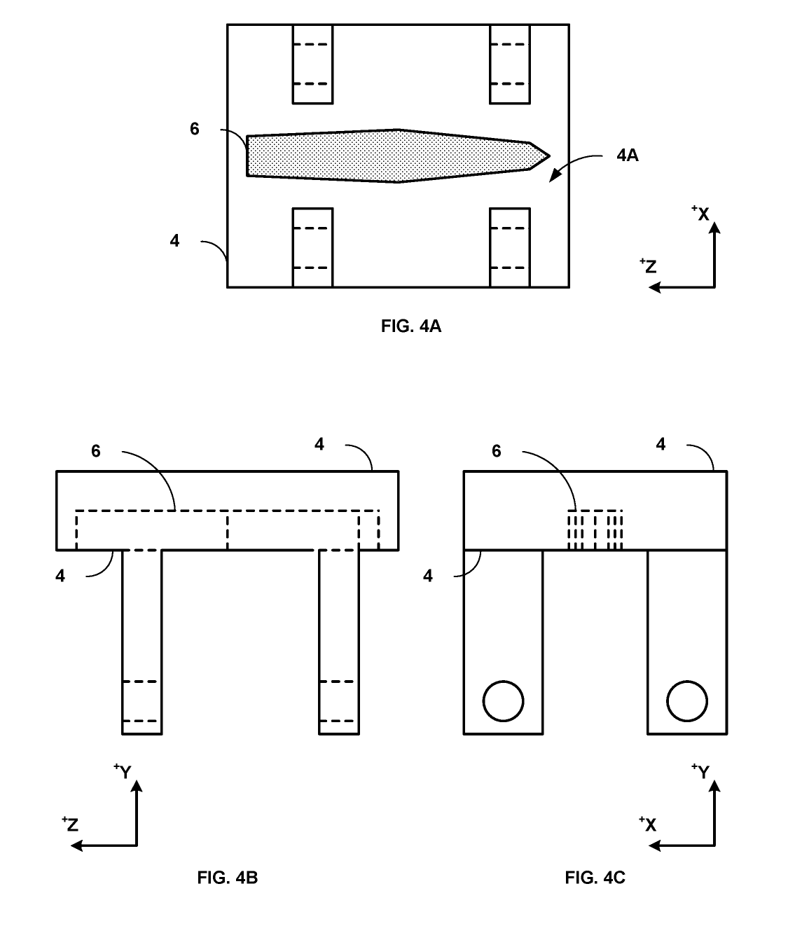

FIGS. 4A-4C are diagrams illustrating additional views of control cover 3 as shown in FIGS. 1-3. FIGS. 4A, 4B, and 4C are views of control cover 3 along the positive Y-axis, the negative X-axis, and the positive Z-axis, respectively. FIGS. 4A-4C are for illustration purposes only and are not to scale.

In the example of FIGS. 4A-4C, cavity 6 of control cover 3 is surrounded on all sides by surface 4A, as shown in FIG. 4A. For example, body portion 4 of control cover 3 may be of uniform thickness around the entire perimeter of surface 4A. Furthermore, as shown in FIGS. 4B and 4C, cavity 6 extends only halfway through body portion 4. The example configuration of control cover 3 may be useful when forming control cover 3 out of relatively less rigid materials, such as plastic or others. In other words, by ensuring that body portion 4 has sufficient material around and behind cavity 6, control cover 3 may be sturdier and less pliable. This may ensure that control cover 3 is more resilient to tampering or misuse when preventing users from changing a secured valve control.

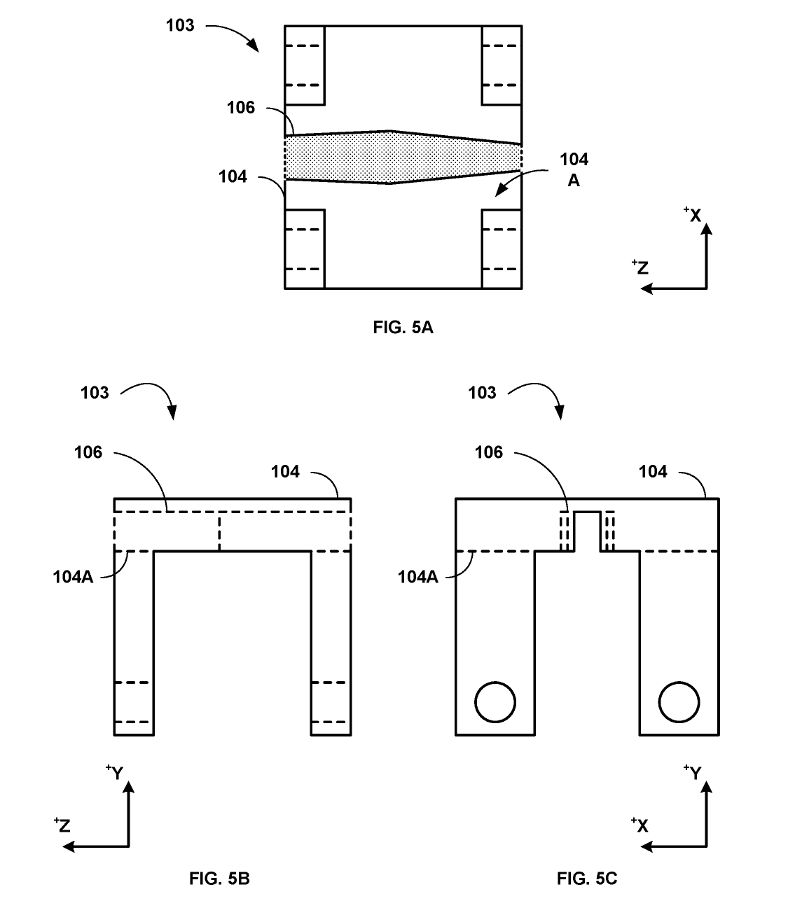

FIGS. 5A-5C are diagrams illustrating example security device control cover 103, in accordance with one or more aspects of the present disclosure. FIGS. 5A, 5B, and 5C are views of control cover 103 along a positive Y-axis, a negative X-axis, and a positive Z-axis, respectively. Control cover 103 may be oriented substantially the same as control cover 3 shown in FIGS. 1-4. In various examples, control cover 103 may be part of a security device that includes backplate 50, locking mechanism 64, alternative backplates or locking mechanisms, and/or other components. FIGS. 5A-5C are for illustration purposes only and are not to scale.

In the example of FIGS. 5A-5C, control cover 103 includes body portion 104 having a front surface 104A. Surface 104A has at least one cavity 106. Cavity 106 of control cover 103 extends to the edges of surface 104A, as shown in FIG. 5A. That is, body portion 104 of control cover 103 may not surround all of cavity 106. Instead, cavity 106 is open ended, such that a valve control inserted into cavity 106 may protrude from the sides of body portion 104.

As shown in FIGS. 5B and 5C, cavity 106 may extend more than halfway through body portion 104. In some examples, cavity 106 may extend almost entirely through body portion 104, leaving only a thin sheet (e.g., 1 mm, 5 mm, etc.) of material behind cavity 106. The example configuration of control cover 103 may be beneficial when control cover 103 is formed out of a relatively more rigid material, such as steel or others. In other words, when control cover 103 is made of a strong, rigid material, body portion 104 may use less material while still ensuring that control cover 103 prevents users from changing a secured valve control.

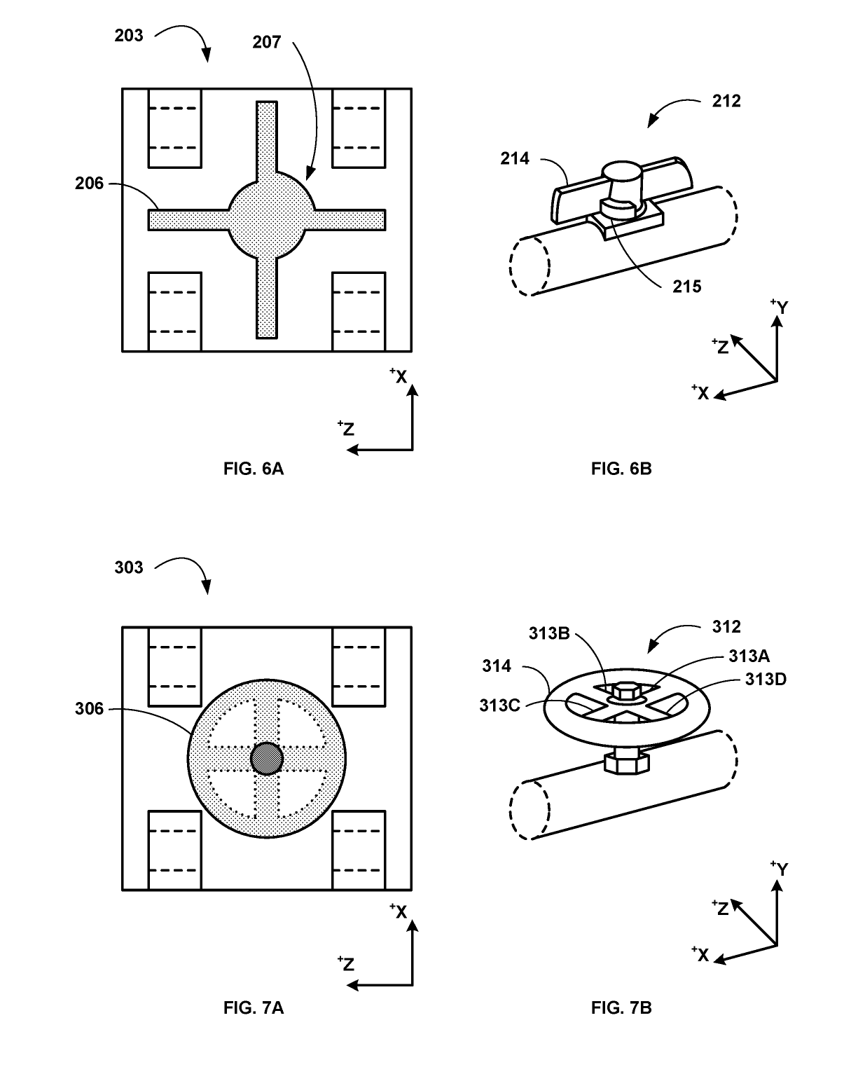

FIGS. 6A and 6B are diagrams illustrating example security device control cover 203 and corresponding valve 212, in accordance with one or more aspects of the present disclosure. FIG. 6A is a view of control cover 203 along a positive Y-axis. FIG. 6B is a perspective view. In various examples, control cover 203 may be part of a security device that may also include a backplate (e.g., backplate 50), a locking mechanism (e.g., locking mechanism 64), and/or other components. FIGS. 6A and 6B are for illustration purposes only and are not to scale.

In the example of FIGS. 6A and 6B, valve 212 includes valve control 214. Valve 212 may be a quarter turn valve. That is, turning valve control 214 approximately 90 degrees may change valve 212 from open to closed. For instance, when valve control 214 is oriented substantially along the X-axis, as shown in the example of FIG. 6B, valve 212 may be open. Valve control 214 may be turned around the Y-axis until valve control 214 is oriented substantially along the Z-axis, at which point, valve 212 may be closed. As shown in the example of FIG. 6B, valve 212 may include stop 215 to ensure that valve control 214 cannot turn more than the intended 90 degrees.

Control cover 203, in the example of FIGS. 6A and 6B, includes at least one cavity 206 in a body of control cover 203. Cavity 206 is shaped such that it may receive at least a portion of valve control 214 both when valve control 214 is substantially in the open position and when valve control 214 is substantially in the closed position. Thus, control cover 214 may be a bi-state control cover, usable to secure valve 212 to ensure either maximum flow through the valve, or minimum (e.g., zero) flow through the valve. In some examples, control cover cavities may be configured to accommodate one or more stationary features of a valve. For instance, in the example shown in FIG. 6A, cavity 206 includes portion 207, which may accommodate stop 215. In some examples, accommodating stationary features of a valve may allow a control cover to receive more of the valve control.

FIGS. 7A and 7B are diagrams illustrating example security device control cover 303 and corresponding valve 312, in accordance with one or more aspects of the present disclosure. FIG. 7A is a view of control cover 303 along a positive Y-axis. FIG. 7B is a perspective view. In various examples, control cover 303 may be part of a security device that may also include a backplate (e.g., backplate 50), a locking mechanism (e.g., locking mechanism 64), and/or other components. FIGS. 7A and 7B are for illustration purposes only and are not to scale.

In the example of FIGS. 7A and 7B, valve 312 includes valve control 314, which includes supports 313A-313D (collectively “supports 313”). Valve 312 may be a gate valve or sluice valve. For instance, rotating valve control 314 in one direction around the Y-axis may incrementally lower a “gate” or wedge inside the valve, thereby incrementally restricting flow until the gate is lowered and flow is cut off. Conversely, rotating valve control 314 in the opposite direction around the Y-axis may incrementally raise the gate, thereby incrementally enabling flow until the gate is raised and flow is unhindered.

Control cover 303, in the example of FIGS. 7A and 7B, includes at least one cavity 306 in a body of control cover 303. Cavity 306 may be shaped such that it may receive at least a portion of valve control 314 in various positions. For instance, cavity 306 may be configured to receive valve control 314 when a pair of opposing supports 313 (e.g., 313A and 313C or 313B and 313D) are substantially parallel to the X-axis. Thus, control cover 314 may be a multi-state control cover, usable to secure valve 312 to ensure various rates of flow through the valve, ranging from a maximum flow to a minimum (zero) flow.

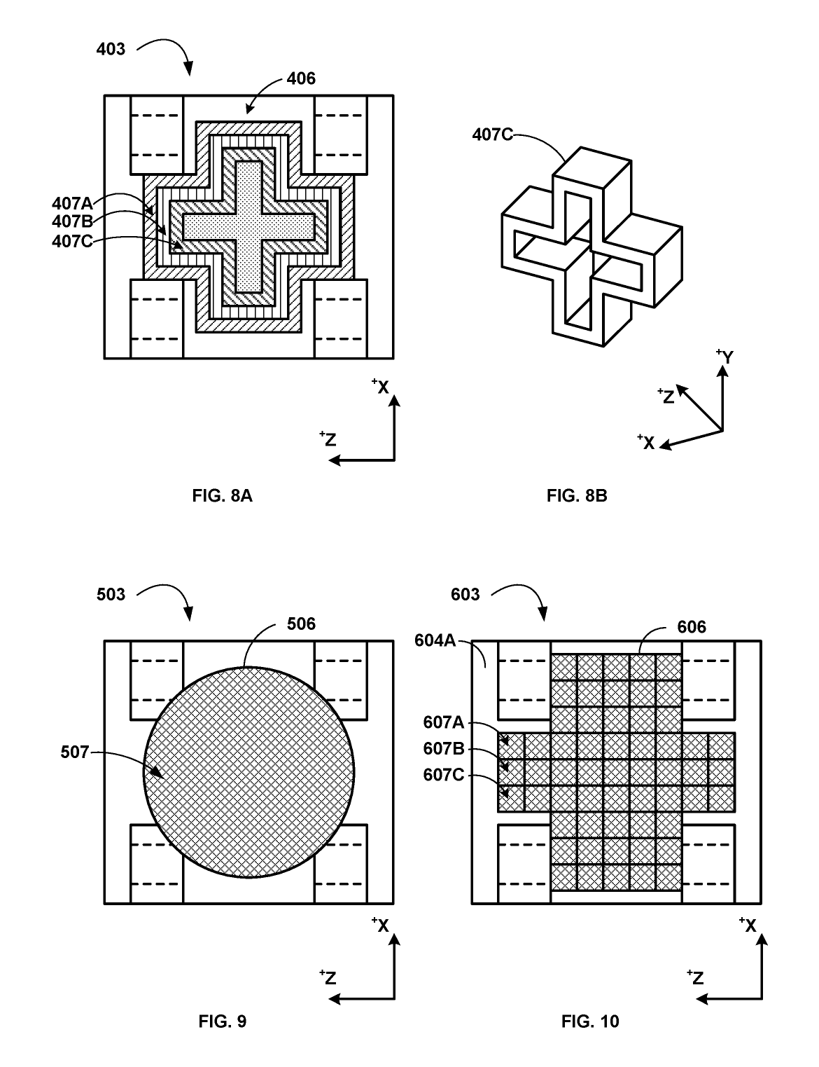

FIGS. 8A and 8B are diagrams illustrating example security device control cover 403 and associated insert 407C, in accordance with one or more aspects of the present disclosure. FIG. 8A is a view of control cover 403 along a positive Y-axis. FIG. 8B is a perspective view. In various examples, control cover 403 may be part of a security device that may also include a backplate (e.g., backplate 50), a locking mechanism (e.g., locking mechanism 64), and/or other components. FIGS. 8A and 8B are for illustration purposes only and are not to scale.

In the example of FIGS. 8A and 8B, control cover 403 includes at least one cavity 406. Control cover 403 also includes inserts 407A-407C (collectively “inserts 407”). One example of insert 407C is shown in FIG. 8B. Inserts 407 may allow control cover 403 to receive different sizes of valve controls. That is, inserts 407 may be rigid or semi-rigid pieces of material that may be inserted into cavity 406 to modify the shape and/or size of cavity 406. Thus, for relatively smaller valves, all of inserts 407 may be inserted into cavity 406. When used to secure relatively larger valves, fewer or even none of inserts 407 may be inserted into cavity 406.

While three inserts are shown in the example of FIGS. 8A and 8B, additional or fewer inserts may be included in various examples. In some examples, inserts 407 may be concentric and/or shaped substantially similarly. In some examples, inserts 407 may not be concentric and/or may be shaped differently from one another. That is, inserts may not only accommodate valve controls of different sizes, but also different types or configurations of valve controls. Furthermore, in some examples, one or more of inserts 407 may also modify prongs of a control cover to accommodate relatively larger or smaller pipes and/or valve housings.

FIG. 9 is a diagram illustrating example security device control cover 503, in accordance with one or more aspects of the present disclosure. In various examples, control cover 503 may be part of a security device that may also include a backplate (e.g., backplate 50), a locking mechanism (e.g., locking mechanism 64), and/or other components. FIG. 9 is for illustration purposes only and is not to scale.

In the example of FIG. 9, control cover 503 includes at least one cavity 506. Compressible material 507 may be disposed within cavity 506. In various examples, compressible material 507 may be any suitable material that is compressible, such as a foam, a sponge material, a gel sac, or others. Compressible material 507 may fill at least a portion of the cavity (e.g., the entire area of, but half the depth of cavity 506; the entire area and depth of cavity 506; half the area and half the depth of cavity 506, or another portion). By disposing compressible material 507 within the relatively larger cavity 506, almost any valve control may be received by control cover 503. As the cover is placed over the valve, the valve control or controls may compress the necessary portions of compressible material 507, thereby forming a custom indentation for the valve controls.

In some examples, compressible material 507 may be a moldable material, such as a clay, a rubber or rubber-like material (e.g., rubberized epoxy) or another material. In some such examples, compressible material 507 may be retained in cavity 506 using, for instance, a plastic film or other flexible containment means. In some examples, a user may press control cover 503 onto a valve control to mold the clay or other moldable material to fit the valve control. In this way, control cover 503 may be fitted to an individual valve control for use multiple times but may later be remolded to fit another, differently shaped valve control.

In some examples, compressible material 507 may be a curable material, such as epoxy resin, silicone, silicone glues, or others. Curable materials may allow an instance of control cover 503 to initially cover and properly restrict movement of any number of valve control shapes but, once compressible material 507 is cured, control cover 503 may be permanently or semi-permanently shaped to fit that particular valve control. In some examples, compressible material 507 may be cured in the field, allowing for easy customization of control cover 503 to an encountered valve control.

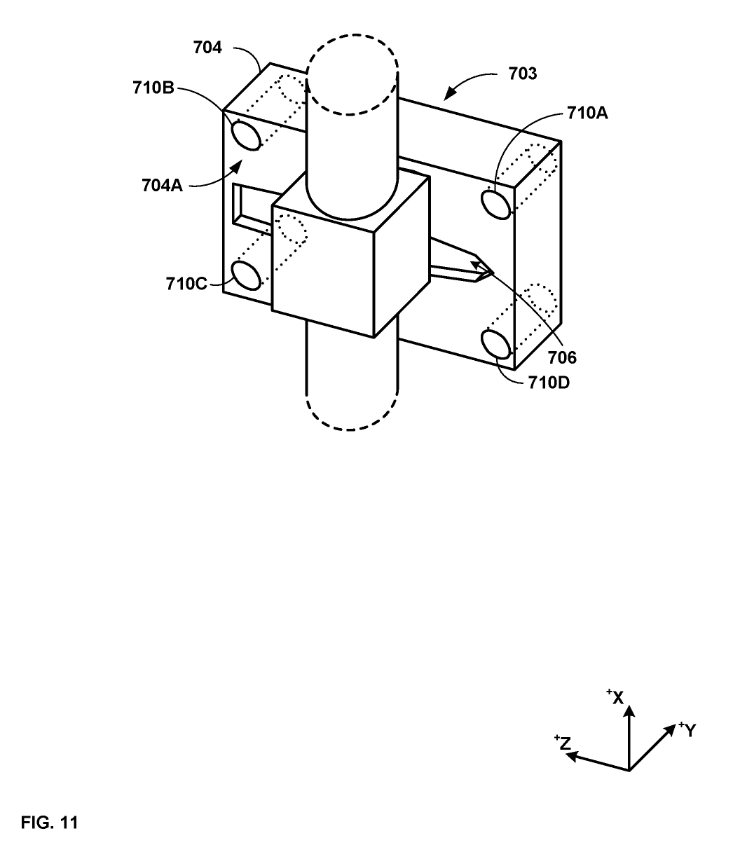

FIG. 10 is a diagram illustrating example security device control cover 603, in accordance with one or more aspects of the present disclosure. In various examples, control cover 603 may be part of a security device that may also include a backplate (e.g., backplate 50), a locking mechanism (e.g., locking mechanism 64), and/or other components. FIG. 10 is for illustration purposes only and is not to scale.

In the example of FIG. 10, control cover 603 includes at least one cavity 606. A sectioned compressible material may be disposed within cavity 606. As shown in the example of FIG. 10, for instance, compressible material sections 607A-607C and others (collectively “sections 607”) may be disposed in cavity 606. In various examples, material sections 607 may be any suitable material that is compressible, such as a foam, a sponge material, a gel sac, or others. The compressible material may be sectioned such that a first section of the compressible material (e.g., section 607B) may be compressed in a direction normal to a front surface 604A of control cover 603 without substantially affecting any other sections of the compressible material (e.g., sections 607A and 607C). Material sections 607 may fill at least a portion of the cavity (e.g., the entire area of, but half the depth of cavity 606; the entire area and depth of cavity 606; half the area and half the depth of cavity 606, or another portion). By disposing material sections 607, made of a compressible material, within the relatively larger cavity 606, a valve control of almost any size and shape may be received by control cover 603. As the cover is placed over the valve, the valve control or controls may compress the necessary ones of material sections 607, while the remaining material sections remain uncompressed, thereby forming a custom indentation for the valve controls. While shown as small squares in the example of FIG. 10, various other shapes and/or configurations of material sections 607 may be used in other examples.

FIG. 11 is a diagram illustrating example security device control cover 703, in accordance with one or more aspects of the present disclosure. In various examples, control cover 703 may be part of a security device that may also include a locking mechanism (not shown) and/or other components. FIG. 11 is for illustration purposes only and is not to scale.

In the example of FIG. 11, control cover 703 includes body portion 704 having surface 704A. Control cover 703 also includes at least one cavity 706 in surface 704A and apertures 710A-D (collectively “apertures 710”). Inner portions of apertures 710 are shown using dotted lines for clarity.

Because control cover 703 does not include any prongs protruding from surface 4A, control cover 703 may be useful when there is little room around a valve control. To restrict movement of a valve control, control cover 703 may be used with other elements, such as one or more locking mechanisms or others.

Apertures 710 may be configured to receive at least one locking mechanism (not shown). As one example, one or more of apertures 710 may be configured to receive a U-shaped shank of an adjustable shackle padlock. The shank may be wide enough to accommodate the valve housing and/or the pipe within the shank, such that the shank may be fitted around the pipe or valve housing, slid through one or more of apertures 710, and attached to the adjustable shackle in order to lock control cover 703 to the valve control. As another example, one or more of apertures 710 may be configured to receive a cable lock that may be wrapped in a number of different configurations around the pipe and/or valve housing. In various examples, apertures 710 may be configured to receive other types of locking mechanisms, such as zip ties or other locking mechanisms.

In some examples, all of apertures 710 may be configured to receive a single locking mechanism (e.g., a cable lock). In some examples, apertures 710 may be configured to receive more than one locking mechanism. For instance, apertures 710A and 710B may be configured to receive the shank of a first adjustable shackle padlock while apertures 710C and 710D may be configured to receive the shank of a second adjustable shackle padlock.

While shown in the example of FIG. 11 as including four apertures, control cover 703 may, in other examples, include more or fewer apertures. In some examples, apertures may be oriented differently than apertures 710 of FIG. 11. For instance, apertures may, in various examples, be oriented vertically (e.g., along the X-axis in FIG. 11), horizontally (e.g., along the Z-axis in FIG. 11), in another orientation and/or in other shapes (e.g., curved apertures, etc.). In some examples, one or more of apertures 710 may be differently sized to accommodate different sized locking mechanisms.

As one additional example of a security device as provided herein, a device may include a control cover that includes a body portion having a first surface, at least one cavity in the first surface, and a plurality of prongs, each of which extends, from the first surface, along a respective axis that intersects the first surface, wherein at least one prong of the plurality of prongs includes a respective aperture configured to receive a locking mechanism.

As another example of a security device as provided herein, a device may include a control cover that includes a body portion having a first surface; at least one cavity in the first surface; compressible material disposed within the cavity that fills at least a portion of the cavity; and at least one aperture configured to receive at least one locking mechanism.

As yet another example of a security device as provided herein, a device may include a control cover that includes a body portion having a first surface; at least one cavity in the first surface; at least one removable insert that, when inserted into the cavity, modifies a shape of the cavity; and at least one aperture configured to receive at least one locking mechanism.

In some examples, the respective aperture of the at least one prong is a respective first aperture, the device further includes a backplate that includes at least one second aperture configured to allow the at least one prong to pass through the backplate, and the respective first aperture is configured to receive the locking mechanism after the at least one prong is fitted through the at least one second aperture, such that the locking mechanism restricts the at least one prong from being removed from the at least one second aperture.

In some examples, the cavity is configured to receive at least a portion of a control of a valve. In some examples, the valve is a quarter-turn valve, and the cavity is configured to: receive the at least a portion of the control when the valve is in an open state, and receive the at least a portion of the control when the valve is in a closed state. In some examples, the cavity is configured to receive the entire control such that the first surface contacts a housing of the valve.

In some examples, the device further includes the locking mechanism. In some examples, the locking mechanism comprises a padlock having a U-shaped shank. In some examples, the at least one prong includes at least two prongs of the plurality of prongs, and the at least two prongs are oriented such that the U-shaped shank is simultaneously insertable through the respective aperture of each of the at least two prongs.

In some examples, the at least one prong includes at least two prongs of the plurality of prongs, and the locking mechanism includes a respective locking mechanism for each of the at least two prongs. In some examples, the control cover further includes: a compressible material disposed within the cavity that fills at least a portion of the cavity. In some examples, the compressible material is sectioned such that compression of a first section of the compressible material does not substantially affect another section of the compressible material.

In some examples, the control cover further includes: at least one removable insert that, when inserted into the cavity, modifies a shape of the cavity. In some examples, the at least one removable insert is one of a plurality of concentric removable inserts, each of which is insertable into the cavity. In some examples, the control cover is made of metal. In some examples, the control cover is made of plastic.

In some examples, at least a part of the body portion is at least partially transparent such that the cavity is viewable through a second surface of the body portion, the second surface being different from the first surface. In some examples, the cavity formed in the first surface does not intersect a surface of the body portion other than the first surface. In some examples, the cavity formed in the first surface intersects a second surface of the body portion, the second surface not being parallel to the first surface.

In some examples, the compressible material is a foam-like material. In some examples, the compressible material is a moldable material. In some examples, the compressible material is a curable material.

The foregoing disclosure includes various examples set forth merely as illustration. The disclosed examples are not intended to be limiting. Modifications of the disclosed examples incorporating the spirit and substance of the described devices may occur to persons skilled in the art. These and other examples are within the scope of the following claims.

What is claimed is:

1. A device comprising:
a control cover comprising:
a body portion having a first surface;
at least one cavity in the first surface; and
a plurality of prongs, each of which extends, from the first surface, along a respective axis that intersects the first surface,
wherein at least one prong of the plurality of prongs comprises a respective aperture configured to receive a locking mechanism.

2. The device of claim 1, wherein:
the respective aperture of the at least one prong comprises a respective first aperture,
the device further comprises a backplate that comprises at least one second aperture configured to allow the at least one prong to pass through the backplate, and
the respective first aperture is configured to receive the locking mechanism after the at least one prong is fitted through the at least one second aperture, such that the locking mechanism restricts the at least one prong from being removed from the at least one second aperture.

3. The device of claim 1, wherein the cavity is configured to receive at least a portion of a control of a valve.

4. The device of claim 3, wherein the valve is a quarter-turn valve, and wherein the cavity is configured to:
receive the at least a portion of the control when the valve is in an open state, and
receive the at least a portion of the control when the valve is in a closed state.

5. The device of claim 3, wherein the cavity is configured to receive the entire control such that the first surface contacts a of the valve.

6. The device of claim 1, further comprising the locking mechanism.

7. The device of claim 6, wherein the locking mechanism comprises a padlock having a U-shaped shank.

8. The device of claim 7, wherein the at least one prong comprises at least two prongs of the plurality of prongs, and wherein the at least two prongs are oriented such that the U-shaped shank is simultaneously insertable through the respective aperture of each of the at least two prongs.

9. The device of claim 6, wherein the at least one prong comprises at least two prongs of the plurality of prongs, and wherein the locking mechanism comprises a respective locking mechanism for each of the at least two prongs.

10. The device of claim 1, wherein the control cover further comprises:
a compressible material disposed within the cavity that fills at least a portion of the cavity.

11. The device of claim 10, wherein the compressible material is sectioned such that compression of a first section of the compressible material does not substantially affect another section of the compressible material.

12. The device of claim 1, wherein the control cover further comprises:
at least one removable insert that, when inserted into the cavity, modifies a shape of the cavity.

13. The device of claim 12, wherein the at least one removable insert is one of a plurality of concentric removable inserts, each of which is insertable into the cavity.

14. The device of claim 1, wherein the control cover is made of metal.

15. The device of claim 1, wherein the control cover is made of plastic.

16. The device of claim 1, wherein at least a part of the body portion is at least partially transparent such that the cavity is viewable through a second surface of the body portion, the second surface being different from the first surface.

17. The device of claim 1, wherein the cavity formed in the first surface does not intersect a surface of the body portion other than the first surface.

18. The device of claim 1, wherein the cavity formed in the first surface intersects a second surface of the body portion, and wherein the second surface is not parallel to the first surface.

19. A device comprising:
control cover comprising:
a body portion having a first surface;
at least one cavity in the first surface;
a compressible material disposed within the cavity that fills at least a portion of the cavity,
at least one aperture configured to receive at least one locking mechanism.

20. A device comprising:
control cover comprising:
a body portion having a first surface;
at least one cavity in the first surface;
at least one removable insert that, when inserted into the cavity, modifies a shape of the cavity; and
at least one aperture configured to receive at least one locking mechanism.
